(19) United States
(12) Patent Application Publication
(10) Pub. No.: US 2008/0081006 A1
(43) Pub. Date: Apr. 3, 2008

(54) Advanced elevated feed distribution system for very large diameter RCC reactor risers

(76) Inventors: Daniel N. Myers, Arlington Heights, IL (US); Paolo Palmas, Des Plaines, IL (US); Daniel R. Johnson, Schaumburg, IL (US); Peter J. Van Opdorp, Naperville, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/541,052

(22) Filed: Sep. 29, 2006

(51) Int. Cl. F27B 15/08

(52) U.S. Cl. 422/145

(57) ABSTRACT

An FCC process and apparatus may include injecting hydrocarbon feedstock at different radial positions inside a riser. Multiple distributors may be used to position the openings for injecting feedstock at multiple radial positions. In addition, the openings may be away from riser peripheral wall and at different elevations along the riser wall or extending up from the riser bottom. The different opening positions introduce the feedstock across a larger area of the cross-section of the riser, which may improve the feedstock dispersion and mixing with catalyst. Improved mixing may increase conversion of the feedstock. Larger FCC units generally have greater riser diameters that may cause problems for feedstock dispersion and decrease the ability for the feedstock to mix with catalyst. Injecting the feedstock at multiple radial positions may improve feedstock dispersion in larger FCC units and increase mixing.

### BACKGROUND OF THE INVENTION

This invention relates generally to a process for catalytic cracking of hydrocarbons.

### DESCRIPTION OF THE PRIOR ART

Fluid catalytic cracking (FCC) is a catalytic conversion process for cracking heavy hydrocarbons into lighter hydrocarbons by bringing the heavy hydrocarbons into contact with a catalyst composed of finely divided particulate material in a fluidized reaction zone. Most FCC units use zeolite-containing catalyst having high activity and selectivity. As the cracking reaction proceeds, substantial amounts of highly carbonaceous material, referred to as coke, are deposited on the catalyst, forming spent catalyst. High temperature regeneration burns the coke from the spent catalyst. The regenerated catalyst may be cooled before being returned to the reaction zone. Spent catalyst is continually removed from the reaction zone and replaced by essentially coke-free catalyst from the regeneration zone.

The basic components of the FCC process include a riser, a reactor vessel, a catalyst stripper, and a regenerator. In the riser, a feed distributor inputs the hydrocarbon feed which contacts the catalyst and is cracked into a product stream containing lighter hydrocarbons. Catalyst and hydrocarbon feed are transported upwardly in the riser by the expansion of the gases that result from the vaporization of the hydrocarbons, and other fluidizing mediums, upon contact with the hot catalyst. Steam or an inert gas may be used to accelerate catalyst in a first section of the riser prior to or during introduction of the feed. Coke accumulates on the catalyst particles as a result of the cracking reaction and the catalyst is then referred to as “spent catalyst.” The reactor vessel disengages spent catalyst from product vapors. The catalyst stripper removes absorbed hydrocarbon from the surface of the catalyst. The regenerator removes the coke from the catalyst and recycles the regenerated catalyst into the riser.

A problem encountered during the FCC process is distributing the feed in the riser so that it can adequately mix with the catalyst. Adequate mixing is usually necessary for efficient conversion of the feed. Larger riser diameters may exacerbate this problem because of the difficulty in distributing the feedstock to the center of the riser.

### SUMMARY OF THE INVENTION

An FCC process and apparatus may include injecting hydrocarbon feedstock at different radial positions inside a riser. Multiple distributors may be used to position the openings for injecting feedstock at multiple radial positions. The different opening positions introduce the feedstock across a larger cross-section area of the riser, which may improve the feedstock dispersion and mixing with catalyst. Improved mixing may increase the efficiency of the FCC process and the conversion of the feedstock. Larger FCC units generally have greater riser diameters which may cause problems for feedstock dispersion, resulting in a decrease in the feedstock mixing with catalyst. Injecting the feedstock at multiple radial positions may improve dispersion and may increase the feedstock mixing with catalyst.

### BRIEF DESCRIPTION OF THE DRAWINGS

FIG. 1 is a cross section taken along segment 1-1 in FIG. 2.

FIG. 2 is an elevational diagram showing an FCC unit.

FIG. 3 is a cross section showing an embodiment with different radial positions between two sets of distributors.

FIG. 4 is an elevational diagram showing a feed distributor.

FIG. 5 is a cross section showing a riser.

FIG. 6 is an elevational diagram showing a distributor tip and a shaping vane.

FIG. 7 is an elevational diagram showing two distributors attached to the wall of a riser with one extending to the approximately the middle of the riser and bending to extend upward.

FIG. 8 is an elevational diagram showing a distributor attached to the wall of the riser and a distributor in a central position extending up from the bottom of a riser.

FIG. 9 is a cross section taken along segment 9-9 in FIG. 8.

FIG. 10 is an elevational diagram showing two distributors attached to the wall of the riser and a distributor in central position extending up from the bottom of a riser.

FIG. 11 is a cross section taken along segment 11-11 in FIG. 10.

### DETAILED DESCRIPTION

This invention relates generally to an improved FCC process and apparatus. Specifically, this invention may relate to an improved feedstock distributor arrangement and may be useful for FCC operation to improve feedstock conversion through greater feed dispersal, especially in larger FCC Units. The process and apparatus could be scaled up or down, as would be apparent to one skilled in the art. The process and apparatus aspects of this invention may be used in the design of new FCC units or to modify the operation of existing FCC units.

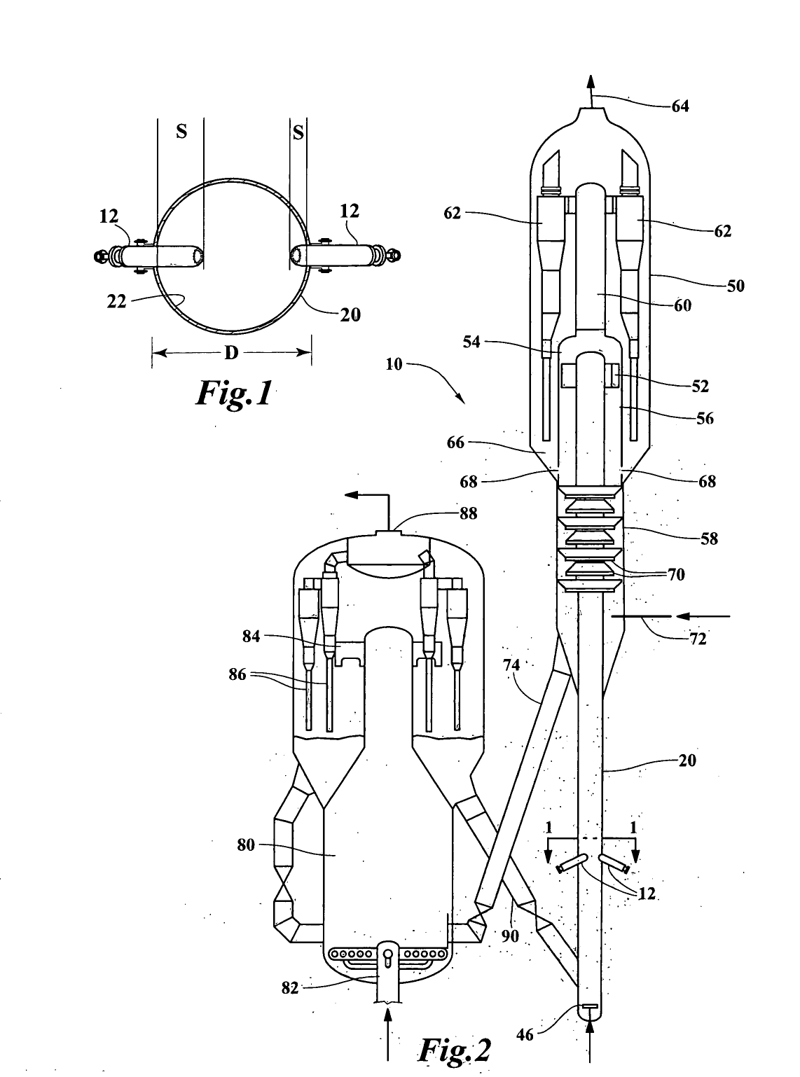

Shown in FIG. 1 is one embodiment of an arrangement of feed distributors 12 illustrating the different radial positions for injecting feedstock into the riser 20.

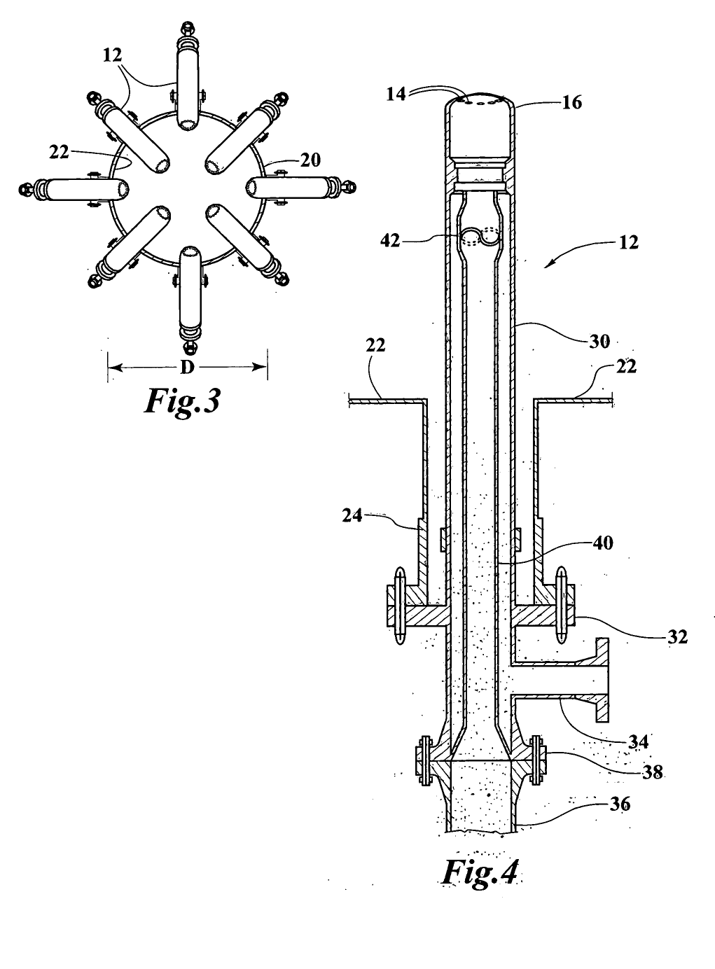

As shown in FIG. 2, an FCC unit 10 may be used in the FCC process. Feedstock may be injected by distributors 12 into the riser 20 where it contacts catalyst and fluidizing mediums. Fluidizing mediums may include inert gas or steam. In general, feedstock may be cracked in the riser 20 in the presence of catalyst to form a cracked stream. Distributors 12 may be at different radial positions to improve feedstock distribution in the riser 20 and mixing with catalyst. Multiple distributors 12, as shown in FIG. 3, may be utilized at different radial positions, preferably at least two per radial position and spaced generally evenly. Distributors 12 of differing capacities may distribute different quantities of feedstock to different areas within the riser to optimize coverage across the riser 20. The differing capacities may range from about 30% to 200% of the average distributor 12 capacity, preferable about 60% to about 150%.

In one embodiment, as shown in FIG. 4, feedstock is injected through one or more orifices, or openings, 14 usually near or on the tip 16. Preferably, a plurality of openings 14 are on the end of the tip 16, arranged in a circular or oval pattern. In addition, multiple circular or oval patterns of openings 14 may be used on one tip 16. At least one distributor 12 may position one of its openings 14 at a different radial position in the riser 20 than another. Referring to FIG. 1, the space S between the opening 14 and the closest portion of the wall 22 may be a distance equal to between about 5% and about 45% of the diameter D of the riser 20, preferably between about 15% and about 35%.

FIG. 4 shows a detail of a distributor 12. In one embodiment, a riser may have a nozzle 24 which engages a distributor barrel 30 by a barrel body flange 32. The distributor barrel 30 receives steam from a steam inlet pipe 34 and oil through an oil inlet pipe 36, secured to the oil inlet flange 38 by bolts. Oil may pass through the internal oil pipe 40 and over vanes 42, causing the oil to swirl before combining with the steam and exiting through the opening 14 in the tip 16.

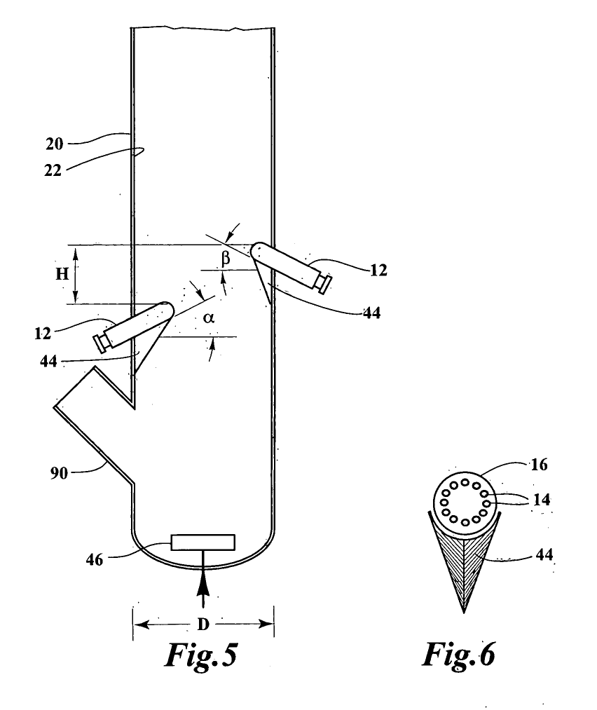

Openings 14 may be positioned at different elevations along the riser 20, as shown in FIG. 5, where the difference in elevation H, or height, between the openings of the distributors is depicted. The difference in elevation H may be a distance equal to between about 15% and 125% of said diameter D. Multiple distributors 12 may be utilized at each of the different elevation H levels in combination with, different radial positions.

As shown in FIG. 5, and in detail in FIG. 6, a shaping vane 44 may be used to direct the flow of materials around the portion of the distributor 12 extending into the inside the riser 20. Shaping vane 44 may be attached to the distributor 12 and to the wall 22 or only to the distributor 12 or wall 22. A refractory coating may cover the surface of the shaping vane 44 or distributor 12, or both, to protect against erosion.

Distributor tip 16, as shown in FIG. 5, may be positioned at angles α or β upward from horizontal. Feedstock may then be injected at an angle upward with the current of the catalyst and fluidizing medium. Angles α and β may differ to optimize coverage. Preferably, these angles α and β are each between about, 15 and about 60 degrees upward from horizon, and more preferably between about 20 and about 40 degrees. Fluidizing medium may be introduced into riser 20, preferably near the bottom, through a steam distributor 46.

As shown in FIG. 2, the injected feed mixes with a fluidized bed of catalyst and moves up the riser 20 and enters the reactor 50. In the reactor 50, the blended catalyst and reacted feed vapors are then discharged from the top of the riser 20 through the riser outlet 52 and separated into a cracked product vapor stream and a collection of catalyst particles covered with substantial quantities of coke and generally referred to as “coked catalyst.” Various arrangements of separators to remove coked catalyst from the product stream quickly may be utilized. In particular, a swirl arm arrangement 54, provided at the end of the riser 20, may further enhance initial catalyst and cracked hydrocarbon separation by imparting a tangential velocity to the exiting catalyst and cracked product vapor stream mixture. The swirl arm arrangement 54 is located in an upper portion of a separation chamber 56, and a stripping zone 58 is situated in the lower portion of the separation chamber 56. Catalyst separated by the swirl arm arrangement 54 drops down into the stripping zone 58.

The cracked product vapor stream comprising cracked hydrocarbons including gasoline and light olefins and some catalyst may exit the separation chamber 56 via a gas conduit 60 in communication with cyclones 62. The cyclones 62 may remove remaining catalyst particles from the product vapor stream to reduce particle concentrations to very low levels. The product vapor stream may exit the top of the reactor 50 through a product outlet 64. Catalyst separated by the cyclones 62 returns to the reactor 50 through diplegs into a dense bed 66 where catalyst will pass through chamber openings 68 and enter the stripping zone 58. The stripping zone 58 removes adsorbed hydrocarbons from the surface of the catalyst by counter-current contact with steam over the optional baffles 70. Steam may enter the stripping zone 58 through a line 72. A coked catalyst conduit 74 transfers coked catalyst to a regenerator 80.

As shown in FIG. 2, the regenerator 80 receives the coked catalyst and typically combusts the coke from the surface of the catalyst articles by contact with an oxygen-containing gas. The oxygen-containing gas enters the bottom of the regenerator 80 via a regenerator distributor 82. Flue gas consisting primarily of N₂, H₂O, O₂, CO₂ and perhaps containing CO, SO₂, SO₃, and NO passes upwardly from the regenerator 80. A primary separator, such as a tee disengager 84, initially separates catalyst from flue gas. Regenerator cyclones 86, or other means, remove entrained catalyst particles from the rising flue gas before the flue gas exits the vessel through an outlet 88. Combustion of coke from the catalyst particles raises the temperatures of the catalyst. The catalyst may pass, regulated by a control valve, through a regenerator standpipe 90 which attaches to the bottom portion of riser 20.

In the FCC process a fluidizing gas such as steam may be passed into the riser 20 to contact and lift the catalyst in the in the riser 20 to the feed point. Regenerated catalyst from the regenerator standpipe 90 will usually have a temperature in a range from about 649° and about 760° C. (1200° to 1400° F.). The dry air rate to the regenerator may be between about 3.6 and about 6.3 kg/kg coke (8 and 14 lbs/lb coke). The hydrogen in coke may be between about 4 and about 8 wt-%, and the sulfur in coke may be between about 0.6 and about 3.0 wt-%. Catalyst coolers on the regenerator may be used. Additionally, the regenerator may be operated under partial CO combustion conditions. Moreover, water or light cycle oil may be added to the bottom of the riser to maintain the appropriate temperature range in FCC unit. Conversion is defined by conversion to gasoline and lighter products with 90 vol-% of the gasoline product boiling at or below 193° C. (380° F.) using ASTM D-86. The conversion may be between about 55 and about 90 vol-% as produced. The zeolitic molecular sieves used in typical FCC gasoline mode operation have a large average pore size and are suitable for the present invention. Molecular sieves with a large pore size have pores with openings of greater than 0.7 nm in effective diameter defined by greater than 10 and typically 12 membered rings. Pore Size Indices of large pores are above about 31. Suitable large pore molecular sieves include synthetic zeolites such as X-type and Y-type zeolites, mordenite and faujasite. Y-type zeolites with low rare earth content are preferred. Low rare earth content denotes less than or equal to about 1.0 wt-% rare earth oxide on the zeolitic portion of the catalyst. Catalyst additives may be added to the catalyst composition during operation.

In one embodiment, the fluidized catalyst is accelerated in the lower riser 20 to reach the distributor 12. Catalyst velocity may be between about 9 and about 30 centimeters per second (0.3 and 1 feet per second), preferably between about 1.5 and about 6.1 meters per second (5 and 20 feet per second). Steam or other inert gas may be employed as a diluent through a steam distributor 46. Only the steam distributor 46 is shown in the FIGURES. However, other steam distributors may be provided along the riser 20 and elsewhere in the FCC unit 10.

The riser 20 may operate with catalyst to oil ratio of between about 4 and about 12, preferably at about 8. Steam to the riser 20 may be between about 3 and about 15 wt-% feed, preferably between about 4 and about 12 wt-%. Before contacting the catalyst, the raw oil feed may have a temperature in a range of from about 149° to about 427° C. (300 to 800° F.), preferably between about 204′ and about 288° C. (400° and 550° F.).

The reactor 80 temperature may operate at a range of between about 427° and 649° C. (800° and 1200° F.), preferably between about 482° and about 593° C. (900° and 1100° F.). The pressure in the reactor 80 may be between about 103 and about 241 kPa (gauge) (15 and 35 PSIG), preferably at about 138 kPa (gauge) (20 PSIG).

The feed pressure drop across the feed distributor 12 may be between about 69 and about 690 kPa (gauge) (10 and 100 PSIG), preferably between about 205 and about 415 kPa (gauge) (30 and 60 PSIG). The steam on feed of the distributor may be between about 0.5 and about 7 wt-%, and preferably between about 1 and 6 wt-%.

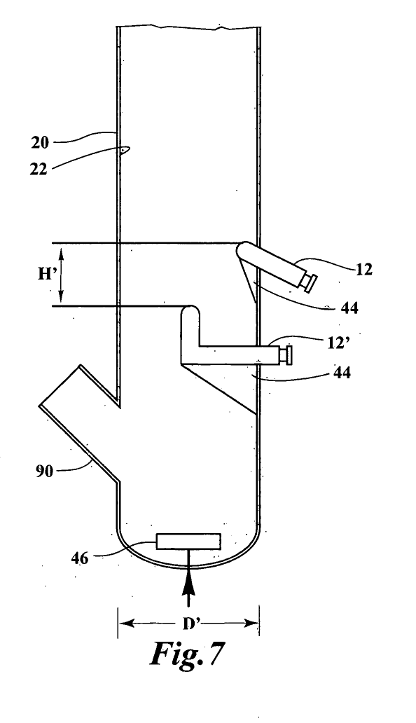

FIGS. 7 through 9 illustrate several additional embodiments of the invention. Elements in FIGS. 7 through 9 which correspond to elements in FIGS. 1-6 but with different configurations will be designated with the same reference numeral but appended with the prime symbol (′). In an embodiment, as shown in FIG. 7, a distributor 12′ is attached to the wall 22 and extends into the riser 20 toward the center and then bends to extend upward. The openings 14 are preferably positioned near the centerline of the riser and inject feedstock upward into approximately the center of the riser 20. In one embodiment, a difference in elevation H′ between a bent distributor 12′ and another distributor 12 attached to the wall 22 would be a distance equal to between about 15% and about 150% of the diameter D′ of the riser 20, preferably between about 50% and about 125%. Using more than one distributor 12 and 12′ is contemplated in this embodiment.

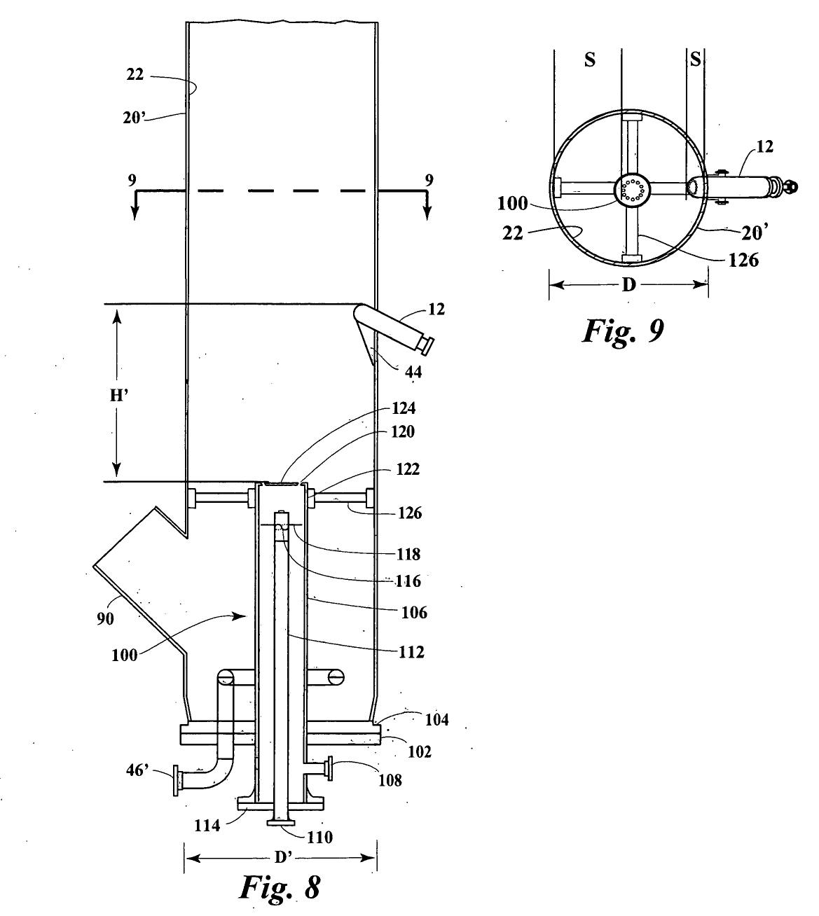

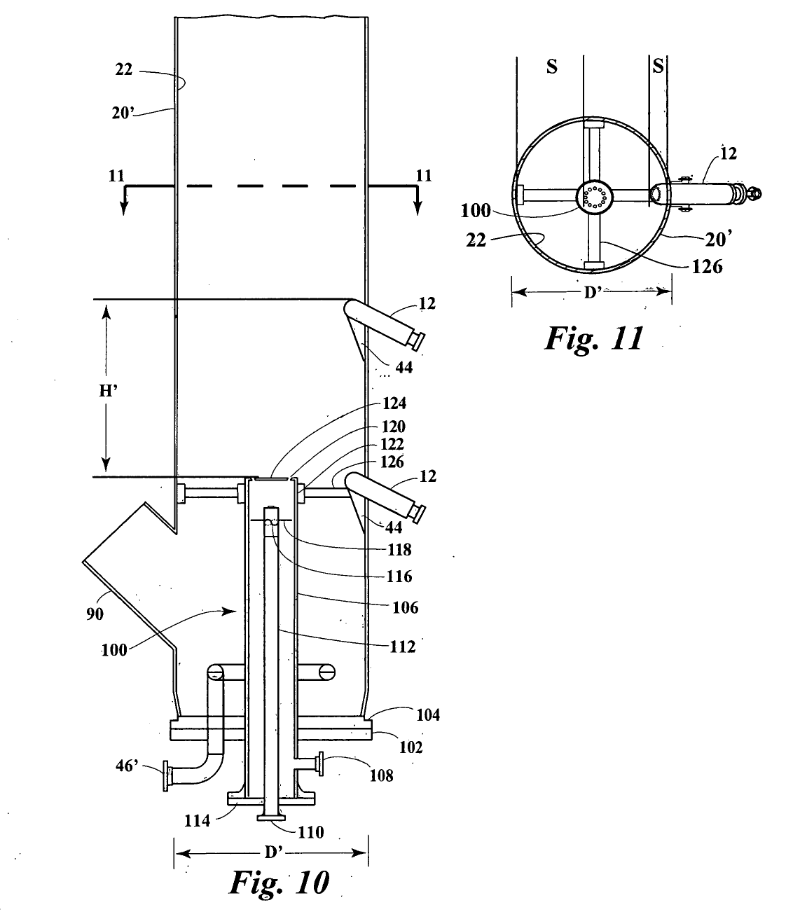

FIGS. 8 and 9 depict a centrally located feed distributor 100 in addition to a feed distributor 12 attached to the wall 22. The center distributor 100 has a different radial position than distributor 12. More than one center distributor 100 may be used. Feed distributor 100 may have a cylindrical configuration and a diameter which increases from its bottom to its top. In one embodiment, a difference in elevation H′ between the center distributor 100 and another distributor 12 attached to the wall 22 would be a distance equal to between about 0% and about 200% of the diameter D′ of the riser 20, preferably between about 25% and about 125%. As shown if FIGS. 10 and 11, a distributor 12 attached to the wall 22 may be positioned at the same elevation as the top of the center distributor 100. Furthermore, two distributors 12 attached to the wall 22 may be positioned at different elevations and radial positions in addition to the center distributor 100.

Feed is introduced from the distributor 100 positioned near the center of the riser 20′, extending upwardly from the bottom of the riser 20′. The distributor 110 is positioned to introduce the feed into approximately the center between the side walls of the riser 20′ and at an elevated position above the input of steam from a steam distributor 46′ and regenerator standpipe 90. In one embodiment, a distributor flange 102 may attach to the base 104 of the riser 20′ by bolts. A distributor barrel 106 receives steam from a steam inlet pipe 108. An oil inlet pipe 110 delivers feedstock to an internal oil pipe 112. An oil inlet barrel flange 114 secures the oil inlet pipe 110 to the distributor barrel 106 by bolts. Vanes 116 in the internal oil pipe 112 cause the oil to swirl in, the oil pipe before exiting. The internal oil pipe 112 distributes the swirling oil to the distributor barrel 106 where it mixes with steam, which passes around a pressure disc 118, and the mixture is injected from orifices, or openings, 120 in the distributor tip 122.

As shown in FIG. 9, the openings 120 may be a series of holes, preferably arranged in a circle around a cap 124, on the top of the tip 122. The space S′ for a center distributor 100 between the opening 120 and the closest portion of the wall 22 may be a distance equal to between about 15% and about 50% of the diameter D′ of the riser 20, preferably between about 35% and about 50%. A bracket attach the distributor 100 to the wall 22′ for stabilization, preferably attaching to the distributor 100 near its tip 122. It is contemplated that the hole pattern in the tip 122 can take other types, of patterns such as concentric circles or other shapes and that a plurality of distributors 100 may be positioned in the riser 20′ to ensure adequate proportionation of the feed. The distributors 12 are available from Bete Fogg Nozzles, Inc.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A fluid catalytic cracking apparatus comprising:
a riser having a top end and a bottom end and a length between said top and bottom ends, a peripheral wall and a diameter defined by said peripheral wall;
at least two distributors;
said at least two distributors each having at least one opening;
said at least one opening of each of said at least two distributors positioned at different radial positions in said riser; and
said at least one opening of at least one of said at least two distributors spaced from said peripheral wall by a distance equal to at least about 10% of said diameter away from closest portion of said wall.

2. The fluid catalytic cracking apparatus according to claim 1, wherein the difference between said radial positions of the at least two distributors is a distance equal to between about 5% and about 45% of said diameter.

3. The fluid catalytic cracking apparatus according to claim 1, wherein the difference between said radial positions of the at least two distributors is a distance equal to between about 15% and about 35% of said diameter.

4. The fluid catalytic cracking apparatus according to claim 1, wherein said at least one opening of at least one of said at least two distributors is positioned from said peripheral wall by a distance equal to between about 15% and 40% of said diameter away from closest portion of said wall.

5. The fluid catalytic cracking apparatus according to claim 1, wherein said at least two distributors are positioned at different elevations along said riser.

6. The fluid catalytic cracking apparatus according to claim 5, wherein said difference between the elevations of each of said openings of said at least two distributors is a distance equal to between about 15% and about 125% of said diameter.

7. The fluid catalytic cracking apparatus according to claim 5, wherein said difference between the elevations of each of said openings of said at least two distributors is a distance equal to between about 25% and about 75% of said diameter.

8. The fluid catalytic cracking apparatus according to claim 1, wherein said at least one opening of at least one of said at least two distributors is positioned at an angle to open in an upwardly direction from horizontal inside said riser.

9. The fluid catalytic cracking apparatus according to claim 1, wherein at least one of said at least two distributors has a different capacity.

10. The fluid catalytic cracking apparatus according to claim 1, wherein said riser has a horizontal component and a vertical component with a vertical centerline at the middle of said diameter and at least one of said at least one distributor attached to said peripheral wall extends from said peripheral wall horizontally and then bends to extend vertically and to position its said at least one opening approximately at said centerline.

11. The fluid catalytic cracking apparatus according to claim 1, wherein at least one of said at least two distributors is attached to said bottom end of said riser.

12. The fluid catalytic cracking apparatus according to claim 11, wherein said at least one distributor attached to said bottom end is positioned with its opening approximately at the middle of said diameter.

13. The fluid catalytic cracking apparatus according to claim 11, wherein said at least one distributor attached to said bottom end is connected to said peripheral wall by a bracket.

14. The fluid catalytic cracking apparatus according to claim 1, further comprising a shaping vane positioned below at least one of said at least two distributors.

15. A fluid catalytic cracking apparatus comprising:
a riser having a top end and a bottom end and a length between said top and bottom ends, a peripheral wall and a diameter defined by said peripheral wall;
at least two distributors;
said at least two distributors each having a diameter and at least one opening;
said at least one opening of each of said at least two distributors positioned at different radial positions in said riser; and
at least one of said at least two distributors attached to said bottom end of said riser.

16. The fluid catalytic cracking apparatus according to claim 15, wherein the difference between said radial positions of the at least two distributors is a distance equal to between about 5% and about 45% of said diameter.

17. The fluid catalytic cracking apparatus according to claim 15, wherein the difference between said radial positions of the at least two distributors is a distance equal to between about 15% and about 35% of said diameter.

18. The fluid catalytic cracking apparatus according to claim 15, wherein said at least one distributor attached to said bottom end has a diameter which increases from said attachment at said bottom end of said riser.

19. The fluid catalytic cracking apparatus according to claim 15, wherein said at least one distributor attached to said peripheral wall is elevated above said at least one opening of said at least one distributor attached to said bottom end by a distance equal to between about 25% and 150% of said riser diameter.

20. A fluid catalytic cracking process comprising:
combining a catalyst and a fluidizing medium in a riser having a top end and a bottom end and a length between said top and bottom ends, a peripheral wall and a diameter defined by said peripheral wall;
passing said catalyst and said fluidized medium upwardly in said riser;
injecting a feedstock into said riser from at least two distributors having openings at different radial positions within said riser and at least one opening of at least one of said at least two distributors spaced from said wall by a distance equal to at least about 10% of said diameter away from closest portion of said wall;
cracking said feedstock in the presence of said catalyst to produce a cracked stream; and
separating said catalyst from said cracked stream.
